(19) United States
(12) Patent Application Publication
(10) Pub. No.: US 2022/0109680 A1
(43) Pub. Date: Apr. 7, 2022

(54) INTERCEPTING DEVICES

(71) Applicant: Hewlett-Packard Development Company, L.P., Spring, TX (US)

(72) Inventors: David Plaquin, Bristol (GB); Pierre Belgarric, Bristol (GB); Christopher Ian Dalton, Bristol (GB); Titouan Lazard, Bristol (GB)

(73) Assignee: Hewlett-Packard Development Company, L.P., Spring, TX (US)

(21) Appl. No.: 17/417,129

(22) PCT Filed: Jun. 24, 2019
(86) PCT No.: PCT/US2019/038736

§ 371 Date: Jun. 22, 2021

(51) Int. Cl. G06F 21/56

(52) U.S. Cl. CPC H04L 63/1416

(57) ABSTRACT

In examples, apparatus for detecting malicious or rogue behaviour associated with data packets transmitted between a first device and a second device through a switch is provided, the first device having direct read/write memory access to the second device, in which the apparatus comprises an intercepting device logically intermediate the first device and the switch device to enable the apparatus to analyse the data packets to determine a communication pattern between the first and second devices, compare the communication pattern to a set of expected behaviours for the first device, select, on the basis of the comparison to the set of expected behaviours, a behaviour pattern for the first device, and map the behaviour pattern for the first device to a set of mitigating actions when the behaviour pattern for the first device is symptomatic of a malicious or rogue behaviour.

### BACKGROUND

Expandable systems, such as computers for example, can comprise a printed circuit board (PCB) (e.g. a motherboard) providing connectors. Some connectors can be in the form of expansion buses enabling peripheral devices to be connected to the system in question.

### BRIEF DESCRIPTION OF THE DRAWINGS

Various features and advantages of certain examples will be apparent from the detailed description which follows, taken in conjunction with the accompanying drawings, which together illustrate, by way of example only, a number of features, and wherein:

FIG. 1 is a schematic representation of a system according to an example;

FIG. 2 is a schematic representation of an intercepting device according to an example; and

FIG. 3 is a flowchart of a method according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

An expansion bus for a computer system that enables connection of a peripheral hardware device, such as a graphic card, storage device (e.g. hard drive, SSD, memory card), Wi-Fi module, Ethernet module and so on, can be a Peripheral Component Interconnect Express (PCIe) expansion bus. PCIe is a high-speed serial expansion bus.

Peripheral devices connected to a system using a PCIe expansion bus form hardware sub-systems that are able to directly access system memory and the memory of other system devices independently of a main processor (CPU) of the system. PCIe supports full duplex direct memory access (DMA) transfers of multiple devices at the same time.

The ability to directly access system memory can enable a peripheral device to transfer data between itself and the system using DMA to read or write directly to main memory without any operating system supervision or interaction, which can enable an attacker to use a peripheral device to gain direct access to part or all of the physical memory address space of the system. The attacker can utilise this direct access to exploit the system by stealing data, keys and modifying the system to enable the use of malware for example.

For example, a rogue peripheral (malicious or corrupted) connected to a PCIe interconnect can attempt to compromise the rest of the system (either by way of the CPU, or another device on the PCIe interconnect). The device in question may have been designed to be rogue, or may be a corrupted device that can be exploited by an attacker and therefore exhibits rogue behaviour or which leverages a non-corrupted device. For example, a malware that uses the network card to communicate with a command and control server.

According to an example, there is provided an apparatus for detecting malicious or rogue behaviour associated with data packets transmitted between a first device and a second device. The data packets can be transmitted between the first and second devices via an intermediate device, such as a switch for example, which forms part of a PCIe interconnect. In an example, the apparatus comprises an intercepting device logically intermediate the first device and the intermediate device.

In an example, the intercepting device (or interceptor) can be logically located between two components of a PCIe interconnect. In an example, multiple interceptors, distributed across multiple PCIe components, and connected together to act as a single entity can be provided. Thus, although examples herein are described with reference to a single intercepting device, this can include a collection of intercepting devices acting together.

According to an example, an intercepting device intercepts PCIe data packets (traffic) travelling on a channel between the two PCIe components or devices in order to:
1) Monitor the traffic to assess whether a communication pattern is symptomatic of a rogue behaviour, or is an expected behaviour from a legitimate device
2) Apply mitigations (e.g. filtering or modification of Transaction Layer Packets (TLPs)) in the case where an abnormal behaviour is detected.

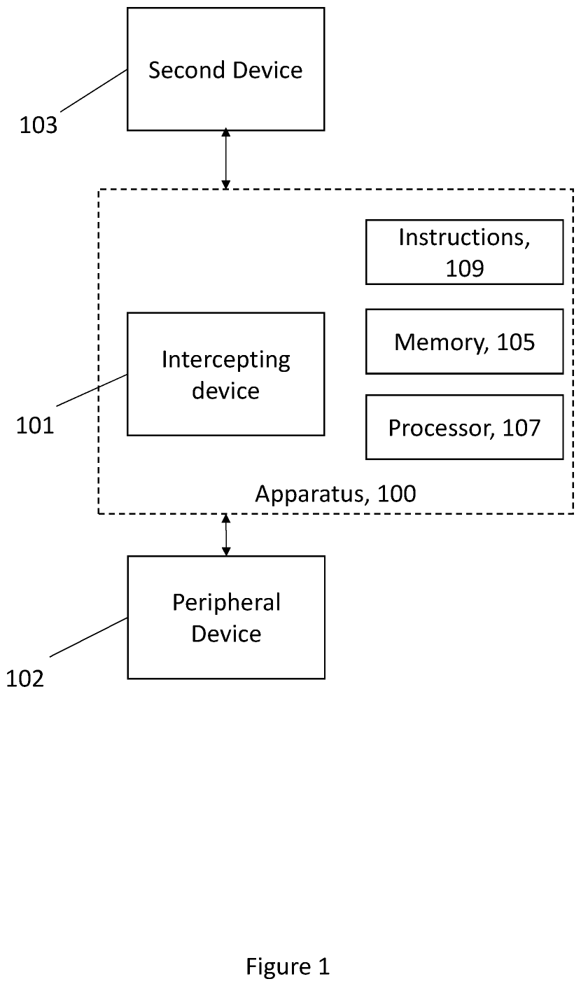

FIG. 1 is a schematic representation of a system according to an example. In the example of FIG. 1, an intercepting device 101 is logically located between a first device (peripheral device 102) and a second device 103. That is, the physical position of an intercepting device 101 may not be between a first device (peripheral device 102) and a second device 103, but its logical position, providing a flow of data packets between a first device (peripheral device 102) and a second device 103 via the intercepting device 101, can be.

According to an example, the second device may be a switch forming part of a PCIe interconnect of a computing apparatus 100. For example, the second device 103 can expose a port that a discrete switch or peripheral can plug into.

In another example, the second device 103 can expose a port that is not a switch but a root port (or a combination of root ports) of the computing apparatus 100. Accordingly, in this example, peripheral device 102 can be effectively directly connected to the second device 103.

In either case, device 102 has direct (read/write) memory access to a memory 105 of the apparatus 100.

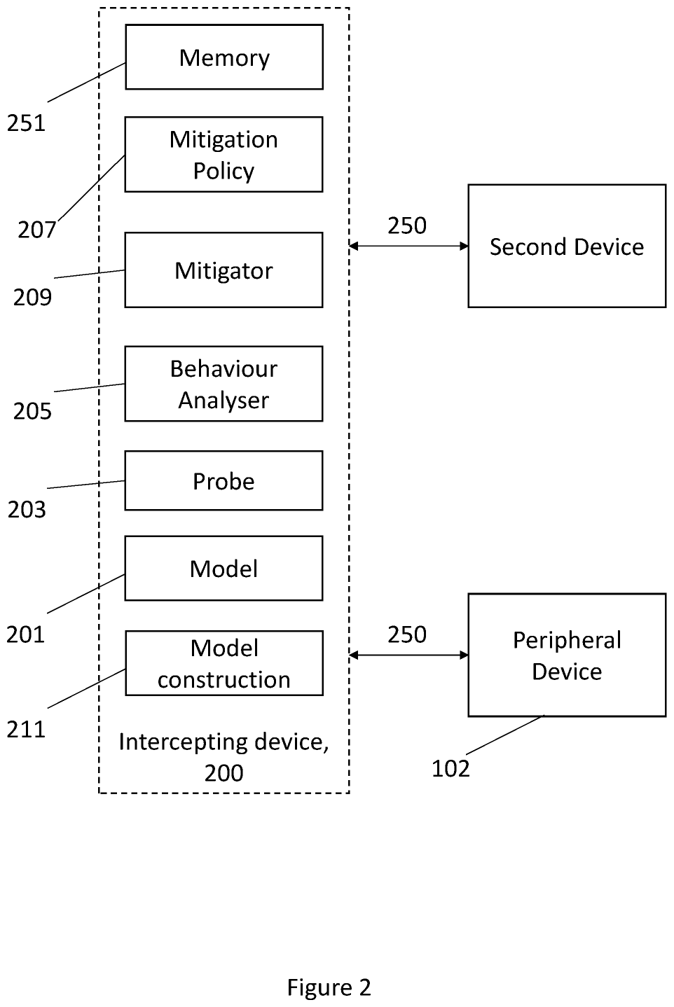

FIG. 2 is a schematic representation of an intercepting device according to an example. In the example of FIG. 2, logical elements are depicted. In some examples, some elements may or may not be in or part of an intercepting device 200, and the different elements of FIG. 2 may be distributed in different hardware devices. In the example of FIG. 2, the different elements are:
1) A model (Behaviour model) 201 that represents a specification of the traffic expected to/from the peripheral(s) 102 observed. This can be composed of a “positive” model where the behaviour described the expected behaviour of a legitimate device, or a “negative” model that describes some malicious behaviours that are known to exist.
2) An element (PCIe probe) 203 to intercept traffic going through a channel between two PCIe components.
3) An element (Behaviour Analyser) 205 to assess the trust in the observed traffic (e.g., legitimate or malicious) that was gathered with PCIe probe 203 and was assessed using the Behaviour model 201.
4) An element (mitigation policy module) 207 to store data representing mitigating actions relating to action to take in case a suspicious traffic is detected.
5) An element (Mitigator) 209 which can apply the Policy from module 207 to the PCIe traffic (TLPs) prior to them leaving the interceptor 200.
6) An element 211 to construct the model 201.

In an example, the logical elements of the device 200 described above can be implemented in hardware, in logic executing on general processing units, or in optimized programmable logic (such as FPGAs for example).

As noted, the interceptor 200 can be logically located between two components of the PCIe interconnect. In other example, several locations could be suitable:
1) It can be a discrete hardware device that is located between two components. It can comprise one upstream port and one downstream port. In this scenario, the intercepting device can be:
   a transparent device on the channel that is invisible from any other component on the PCIe interconnect. This also means that the device need not impact different aspects from a specification, e.g., a timing constraint on the channel. The interceptor can get packets going through it, or it could be on a redirected channel parallel to the original one, thus having less of an impact on the constraints of the channel.
   provided as a switch with one upstream port and one downstream port, thus being visible in the PCIe infrastructure. The consequence being on the lower layers of the PCIe protocol stack (e.g., DLLPs).
2) It could be integrated as an additional security mechanism in traditional PCIe components, e.g., switches or peripherals. Here, the PCIe infrastructure would be the same physically (in terms of discrete devices) as the one it would have otherwise been. In an example, the intercepting device can be an in-package chip, or an IP block within the SoC of a component, or some isolated environment running concurrently with the rest of the logic, such as a trusted module for example (e.g. trusted platform module). The interceptor can thus be hardened against attacks, helping against attacks that would corrupt the rest of the component, (e.g. legacy PCIe functionality).
3) The intercepting device can be integrated within the “uncore” of the combined processor and chipset of a system. In an example, the uncore contains the root port and some integrated peripherals. This internal part of the PCIe interconnect is logically seen according to the PCIe specification (even if it is implemented in a way that is not physically like a PCIe interconnect, but yet provides that view). The interceptor could be some logic added in the uncore to monitor the communication happening between the two physical representations of two logical components.

According to an example, model 201 can be built to differentiate between legitimate and rogue communication coming to and from a peripheral device 102. In an example, in order to make this differentiation, the intercepting device 200 can comprise some information about the peripheral device 102 in order to assess the compliance of the monitored traffic to the peripheral device's expected incoming and outgoing traffic. Thus, a model 201 can represent the expected traffic of a peripheral device 102.

According to an example, a model 201 can be built using module 211 in several ways to account for the expected traffic to and from the device:
Traffic monitoring. The interceptor 200 can build the model 201 from the traffic 250 to/from the device 102. For example, using configuration request TLPs and memory request TLPs, it is possible to construct a model of the interaction expected by the driver associated to the peripheral 102 on the processor side of the apparatus 100. If the peripheral starts accessing (via DMA for example) some data that it should not access but that is in pages that are mapped, the interceptor 200 could determine this.
Driver static analysis. A model of the expected interaction of the device 102 can be constructed via static analysis of the driver that is going to handle the interaction with the device 102. This can be done on the processor side of the apparatus 100. For example, the interceptor 200 can obtain information about the driver that is loaded on the processor side, and performs static analysis on a replica of the driver. This static analysis of the driver's replica could for example be done on a remote device the interceptor can communicate with, e.g., via the internet. The driver can be pre-installed in an internal storage 251 of the intercepting device 200 and the analysis done locally.
Driver dynamic analysis. The model 201 can be built with an observation of driver inputs/outputs, and its internal state. This analysis could be passive, e.g., building the model by monitoring passively the APIs of the driver, or making the driver run within an interpreter. The analysis could also be active, with an active probing of the APIs, e.g., with the solution crafting inputs to get information about the driver.
In-driver model structure. The driver could be provided with a structure that represents the peripheral's expected traffic and that the interceptor understands and can load. The model can then be added before the driver is made available for use. In an example, the model can be transferred in a secure way from the list to the interceptor before traffic to/from the device is allowed.
OS/Application analysis: The model can be derived either from static analysis (either automatic or manual) from the OS and application source code or by traffic monitoring (similar to above) of the traffic generated by legitimate OS and applications.

In an example, intercepting device 200 can be comprised of one or multiple interceptor instances. That is, device 200 can be formed from multiple interceptor instances, each of which can be logically positioned between a (e.g. different or same) peripheral(s) and the second device. For example, an interceptor instance can be a physical intercepting device, or an interceptor instantiation that is configured to execute over or on the physical hardware of an apparatus. Any combination of physical and non-physical (i.e. logic based) interceptors (as described above for example) can be provided.

The location of an interceptor 200 determines the traffic it can observe and apply mitigations to. Thus, a set of interceptor instances can increase the coverage of traffic observed and mitigated. In case there are several interceptor instances, they can interact with each other to help with a more globally encompassing solution. Each interceptor instance can use information from other interceptor instances, whether about the traffic it cannot itself observe, or combine their models, or combine the logic for the assessment of the traffic compliance with the local model for peripherals it has no visibility upon.

In an example, the model 201 could be split in different ways. For example, interceptor instances can communicate with a trusted compute engine. The interceptor would use this compute engine to outsource heavyweight computations for example. The interceptor could still handle some of the compute according to the overall design. For example, the split between the interceptor and the compute engine can be configured according to various parameters such as latency, energy consumption, communication capabilities, security of the overall design, and so on.

Thus, in a case where there are several interceptor instances, these interceptor instances could communicate between each other. This could be useful for each interceptor to gather information gleaned by other interceptors, and to adapt its state and behaviour accordingly.

Accordingly, an intercepting device 200 can be used to detect and mitigate threats at a hardware level. As such, as an OS is not used to configure various PCIe hardware elements, it is not included in a trusted computing base. This reduces the attack surface (even if an attacker manages to compromise the OS, rogue devices can still be detected and protected against), and can even detect compromise of the OS/Application.

Furthermore, it is possible to detect and mitigate against attacks from a rogue PCIe device to another PCIe device, which are usually invisible to the OS.

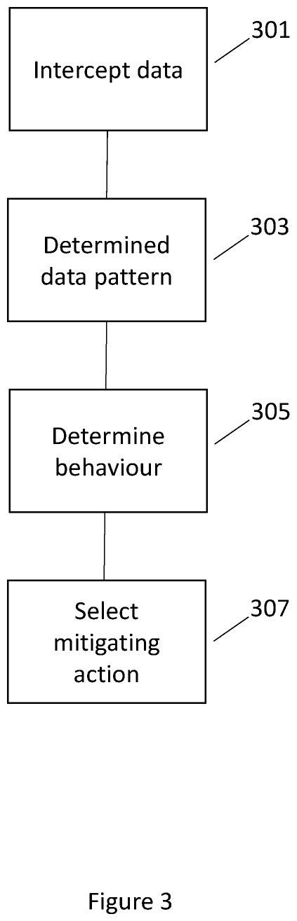

FIG. 3 is a flowchart of a method according to an example. The example of FIG. 3 relates to a method for detecting malicious or rogue behaviour associated with data packets transmitted between a first device 102 and a second device 103, the first device having direct read/write memory access privileges with the second device. In block 301, data flowing through a between the first and second devices is intercepted, such as by an intercepting device 200 as described above. In an example, the data can be flowing via a switch, which can be part of a PCIE interconnect for example.

In block 303, a communication pattern relating to the data flowing between the first and second devices is determined. For example, module 211 can use the data 250 to build or otherwise refine a model 201 representing data flow between the first and second devices. In block 305, the communication pattern is used to determine whether the data flowing between the first and second devices is symptomatic of a malicious or rogue behaviour of the first device. For example, the communication pattern can be compared to an expected behaviour of the device 102 from model 201 using analyser 205 in order to determine if the behaviour conforms to or departs from an expected behaviour. In block 307, a mitigating action is selected based on a relationship between the communication pattern and an expected behaviour of the first device. The action can be applied using mitigator 209 from action data stored in 207, for example.

Examples in the present disclosure can be provided as methods, systems or machine-readable instructions, and as any combination of hardware, firmware or the like. Such machine-readable instructions may be included on a computer readable storage medium (including but not limited to disc storage, CD-ROM, solid state or optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus (for example, module(s) of the intercepting device 200) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

Referring to FIG. 1, an example of a processor 107 associated with a memory 105 in apparatus 100 is depicted. The memory 105 can comprise computer readable instructions 109 which are executable by the processor 107. The instructions 109 can comprise instructions to analyse data packets transmitted between a first device and a second device to determine a communication pattern between the first and second devices; compare the communication pattern to a set of expected behaviours for the first device; select, on the basis of the comparison to the set of expected behaviours, a behaviour pattern for the first device; and map the behaviour pattern for the first device to a set of mitigating actions when the behaviour pattern for the first device is symptomatic of a malicious or rogue behaviour.

Such machine readable instructions may also be loaded onto a computer or other programmable data processing devices, so that the computer or other programmable data processing devices perform a series of operations to produce computer-implemented processing, thus the instructions executed on the computer or other programmable devices provide a operation for realizing functions specified by flow(s) in the flow charts and/or block(s) in the block diagrams.

Further, the teachings herein may be implemented in the form of a computer product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. An apparatus for detecting malicious or rogue behaviour associated with data packets transmitted between a first device and a second device through a switch, the first device having direct read/write memory access privileges to the second device, comprising an intercepting device logically intermediate the first device and the switch device to enable the apparatus to:
analyse the data packets to determine a communication pattern between the first and second devices;
compare the communication pattern to a set of expected behaviours for the first device;
select, on the basis of the comparison to the set of expected behaviours, a behaviour pattern for the first device; and
map the behaviour pattern for the first device to a set of mitigating actions when the behaviour pattern for the first device is symptomatic of a malicious or rogue behaviour.

2. The apparatus as claimed in claim 1, wherein the intercepting device comprises multiple interceptor instances.

3. The apparatus as claimed in claim 2, wherein the multiple interceptor instances are communicatively coupled, whereby to enable them to interact with one another.

4. The apparatus as claimed in claim 3, wherein an interceptor instance can use information from other interceptor instances relating to traffic between the first and second devices.

5. The apparatus as claimed in claim 1, further comprising a trusted module to receive the data packets.

6. The apparatus as claimed in claim 5, wherein the trusted module is positioned logically separately from the intercepting device and processes the data packets to provide the set of mitigating actions.

7. The apparatus as claimed in claim 1, the intercepting device to use the data packets to generate an expected behaviour for the first device, or modify a pre-existing expected behaviour for the first device.

8. The apparatus as claimed in claim 1, wherein the intercepting device is a physical device located intermediate the first device and the switch device.

9. The apparatus as claimed in claim 1, wherein the intercepting device is a physical device located within or as part of the switch device.

10. The apparatus as claimed in claim 1, wherein the switch forms part of a Peripheral Component Interconnect Express (PCIe) interconnect of the second device.

11. A method for detecting malicious or rogue behaviour associated with data packets transmitted between a first device and a second device, the first device having direct read/write memory access privileges with the second device, the method comprising:
intercepting data flowing through a switch between the first and second devices;
determining a communication pattern relating to the data flowing between the first and second devices;
using the communication pattern, determining whether the data flowing between the first and second devices is symptomatic of a malicious or rogue behaviour of the first device; and
selecting a mitigating action based on a relationship between the communication pattern and an expected behaviour of the first device.

12. The method as claimed in claim 11, further comprising:
using the data flowing through the switch, generating the expected behaviour for the first device, or modifying a pre-existing expected behaviour for the first device.

13. The method as claimed in claim 11, further comprising intercepting the data flowing through the switch between the first and second devices at a point logically intermediate the first device and the switch.

14. The method as claimed in claim 11, further comprising intercepting the data flowing through the switch between the first and second devices at multiple positions between the first and second devices.

15. The method as claimed in claim 11, wherein a mitigating action includes enabling continuation of transmission of the data packets between the first device and the second device.
